(19) United States
(12) Patent Application Publication
(10) Pub. No.: US 2003/0040950 A1
(43) Pub. Date: Feb. 27, 2003

(54) Production planning calculating apparatus and production planning calculating program

(75) Inventors: Masayuki Iwasaka, Tama-shi (JP); Kenichi Adachi, Hachioji-shi (JP)

Correspondence Address: Scully, Scott, Murphy & Presser, 400 Garden City Plaza, Garden City, NY, 11530, US

(73) Assignee: OLYMPUS OPTICAL CO., LTD., TOKYO (JP)

(21) Appl. No.: 10/198,837

(22) Filed: Jul. 19, 2002

(30) Foreign Application Priority Data
Jul. 19, 2001 (JP) 2001-220002

(51) Int. Cl. G06F 17/60

(52) U.S. Cl. 705/8

(57) ABSTRACT

A production planning calculating apparatus includes a reprocess information input unit which inputs reprocess information in accordance with a reprocessing of a particular reprocess apparatus sent from a particular medical facility. A reprocess reference information storage unit stores reference information based on a possible value for reprocessing in the particular reprocess apparatus. A production planning information calculating unit calculates production planning information on the particular reprocess apparatus, based on the reprocess information input from the reprocess information input unit and the reference information stored in the reprocess reference information storage unit.

### CROSS-REFERENCE TO RELATED APPLICATIONS

This application is based upon and claims the benefit of priority from the prior Japanese Patent Application No. 2001-220002, filed Jul. 19, 2001, the entire contents of which are incorporated herein by reference.

### BACKGROUND OF THE INVENTION

1. Field of the Invention

The present invention relates to a production planning calculating apparatus and a production planning calculating program.

2. Description of the Related Art

Conventionally, reusable instruments have been reprocessed by a hospital that used the relevant instruments, or by a company specialized in reprocessing, which was consigned by the hospital. In this description, the word, reprocess, means a process in that the instruments used in a hospital are collected and disinfected or sterilized so as to reuse the relevant instruments. Also, a company that especially carries out such work is called a company specialized in reprocessing.

In the case where an instrument cannot be reused due to damage etc., they have been discarded by each hospital. When the stock of instruments is run out, the hospital purchases the instrument from a vendor. When the stock is run out in the vendor side, the vendor purchases the instrument from a wholesale distributor, and further, when the stock is run out, the wholesale distributor purchases the instrument from a manufacturer. Based on an order for the instrument from the wholesale distributor, the manufacturer has made a production plan for the instrument while estimating the later consumption.

In this case, the manufacturer has made a production plan while estimating the later consumption based on the past results that was ordered from the wholesale distributor, i.e., the fact occurred in the past. Therefore, the accuracy in the plan deteriorates. Accordingly, it has been necessary for the manufacturer to have the larger stock so as not to hold back orders.

Similarly, the hospital, vendor and wholesale distributor secure instruments in stock with estimation based on the fact that occurred in the past. Therefore, the stock exists in each of the above parties, resulting in that a quite large of stock exists in the whole distribution process.

As described above, a stock requires the management expense, which results in that the cost for an instrument increases by an amount corresponding to that expense. In addition, in the case where a product has been improved for example, if the stock were not run out, the improved product would not come to a user. Therefore, quite a time difference occurs for the user to receive the benefit provided by the improvement. In order to eliminate the time difference, the only way has been to dispose the stock.

Further, when a product remains in the distribution process for a long time, the substantial term of validity after receiving the product by the user may be shortened.

### BRIEF SUMMARY OF THE INVENTION

In view of the above-described status, an object of the invention is to provide a production planning calculating apparatus and a production planning calculating program, which have the capability of reducing the degree in that a production plan depends on an estimation based on the order results occurred in the past to the minimum extent.

To achieve the above object, a production planning calculating apparatus according to a first aspect of the invention comprising:

a reprocess information input unit which inputs reprocess information in accordance with a reprocessing of a particular reprocess apparatus sent from a particular medical facility;

a reprocess reference information storage unit which stores reference information based on a possible value for reprocessing in the particular reprocess apparatus; and

a production planning information calculating unit which calculates production planning information on the particular reprocess apparatus, based on the reprocess information input from the reprocess information input unit and the reference information stored in the reprocess reference information storage unit.

Further, a production planning calculating apparatus according to a second aspect of the invention comprises:

an apparatus identification information input unit capable of inputting apparatus identification information to identify a particular reprocess apparatus;

a medical facility information input unit capable of inputting information on medical facility which possesses the particular reprocess apparatus;

a reprocess number information input unit capable of inputting information on the reprocess number corresponding to the reprocess number to the particular reprocess apparatus;

a reprocess information managing unit which manages the apparatus identification information, medical facility information, and the reprocess number information in a manner of corresponding respectively;

an average reprocess number calculating unit which calculates information on the average possible reprocess number in a particular medical facility, based on the apparatus identification information, medical facility information, and the reprocess number information, these pieces of information being managed by the reprocess information managing unit; and

a production planning information calculating unit which calculates production planning information of the particular reprocess apparatus, based on the apparatus identification information, medical facility information, and the reprocess number information, these pieces of information being managed by the reprocess information managing unit.

Further, a production planning calculating apparatus according to a third aspect of the invention comprises:

a reprocess information input device which input reprocess information in accordance with a repressing of a particular reprocess apparatus sent from a particular medical facility;

a production planning information output device which calculates production planning information on the particular reprocess apparatus and outputs the calculated information, with use of the reprocess information input through the reprocess information input device and reference information based on a possible value for reprocessing in the particular reprocess apparatus; and

a communication device which connects the reprocess information input device and the production planning information output device to each other and enables reception and/or transmission of information between the devices.

Furthermore, a production planning calculating program according a fourth aspect of the invention causing a computer to realize:

a reprocess information input function which inputs reprocess information in accordance with a reprocessing of a particular reprocess apparatus sent from a particular medical facility;

a reprocess reference information storage function which stores reference information based on a possible value for reprocessing in the particular reprocess apparatus; and

a production planning information calculating function which calculates production planning information on the particular reprocess apparatus, based on the reprocess information input through the reprocess information input function and the reference information stored by the reference information storage function.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram for explaining an outline of the whole service provided by the present invention;

FIG. 2 is a diagram showing a specific construction for realizing the invention;

FIGS. 3A, 3B, 3C and 3D are diagrams showing the details of various pieces of information accumulated in a database;

FIG. 4 is a diagram for explaining the movement of an instrument and information according to the invention;

FIG. 5 is a diagram for explaining a function of an A-block shown in FIG. 4;

FIG. 6 is a diagram for explaining a function of a B-block shown in FIG. 4;

FIG. 7 is a diagram for explaining a function of a C-block shown in FIG. 4;

FIG. 8 is a diagram showing a device to identify an individual piece of instruments;

FIG. 9 is a diagram showing a collection box with a transponder reading device;

FIG. 10 is a graph showing a bathtub curve indicating the relationship between the failure incidence rate and the number of use;

FIGS. 11A and 11B are diagrams for explaining an embodiment of forming discard schedule information depending on whether or not an operation competence satisfies the standard value;

FIGS. 12A and 12B are diagrams for explaining an is embodiment of forming discard schedule information depending on whether or not a form of an instrument satisfies the standard; and

FIG. 13 is a diagram for explaining an embodiment of forming discard schedule information depending on whether or not the deflection of a sheath for an instrument satisfies the standard value.

### DETAILED DESCRIPTION OF THE INVENTION

Hereinafter, an embodiment of the present invention will be described with reference to the accompanying drawings. In the embodiment, the fact is focused in that, when a reprocessing is performed to a reprocess apparatus (e.g. instrument), the degree of the consumption of an instrument is generally checked and it is determined whether or not the relevant instrument can be reused. Then, a system is to be developed in that a manufacturer can directly grasp the degree of the instrument consumption checked at the time of reprocessing through electric communication circuit etc. so as to reflect the grasped fact to a production plan.

More specifically, in an surrogate service of reprocessing instrument for an endoscope such that the instruments used in a hospital are collected, applied with a reprocessing treatment and then returned to the hospital, the system comprises an input section which inputs a usage status of an instrument at the time of reprocessing, an information accumulation center which receives the input information through an electric communication circuit and unifies the management of the received information, and check section which checks the received information at a production factory of the instrument, thereby developing a production plan based on the checked result provided through the check section.

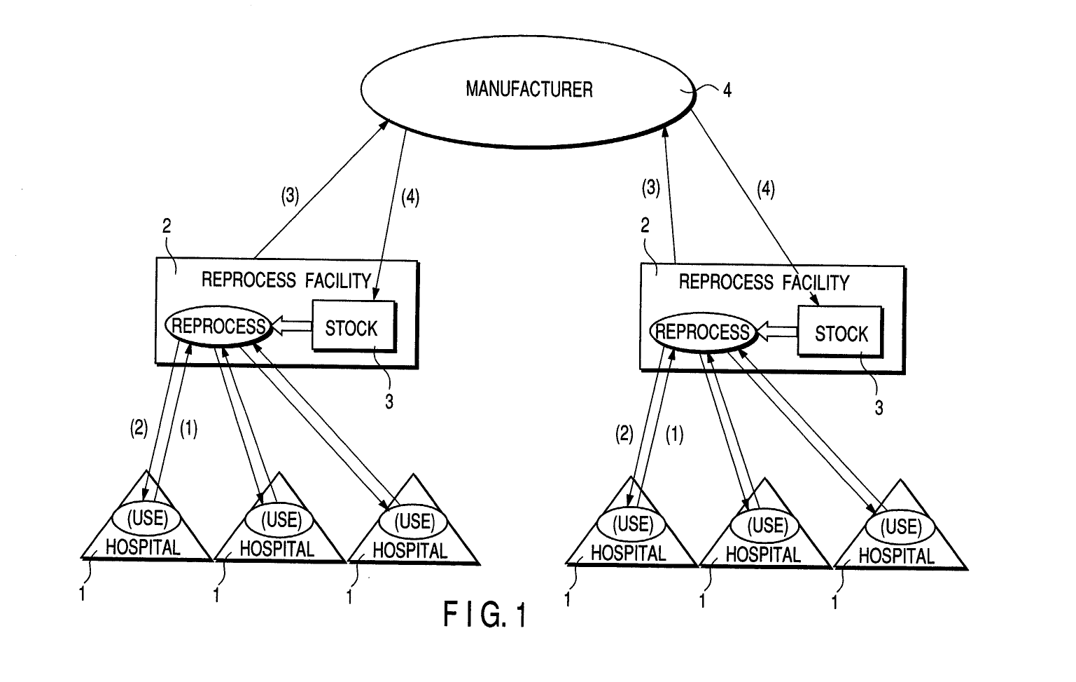

An outline of the whole service provided through the invention now will be described with reference to FIG. 1. A production planning calculating apparatus according to the embodiment is constituted by a plurality of hospitals 1, a plurality of reprocess facilities 2, and a manufacturer 4. These parties are connected to one another through a communication circuit to be described later. The instruments used in the hospitals 1 are collected to the reprocess facilities 2 (Arrow (1)). In the reprocess facilities 2, the collected instruments are reprocessed so as to turn them into a reusable status. At this time, the instruments determined not to be able to reuse are discarded, and new instruments stored in stocks 3 in the reprocess facilities 2 are replenished. The instruments that are in a reusable state and the replenished instruments are returned to the former hospitals (Arrow (2)).

In addition, when the new instruments are replenished from the stocks 3, the reprocess facilities 2 transmit instrument replenish information on there instruments to the manufacturer 4 (Arrow (3)).

On receiving the transmitted information, the manufacturer 4 makes a production plan for the instruments based on this information. Further, the manufacturer 4 produces the instruments along the production plan and sends new instruments to the reprocess facilities 2 that are in short of stock (Arrow (4)).

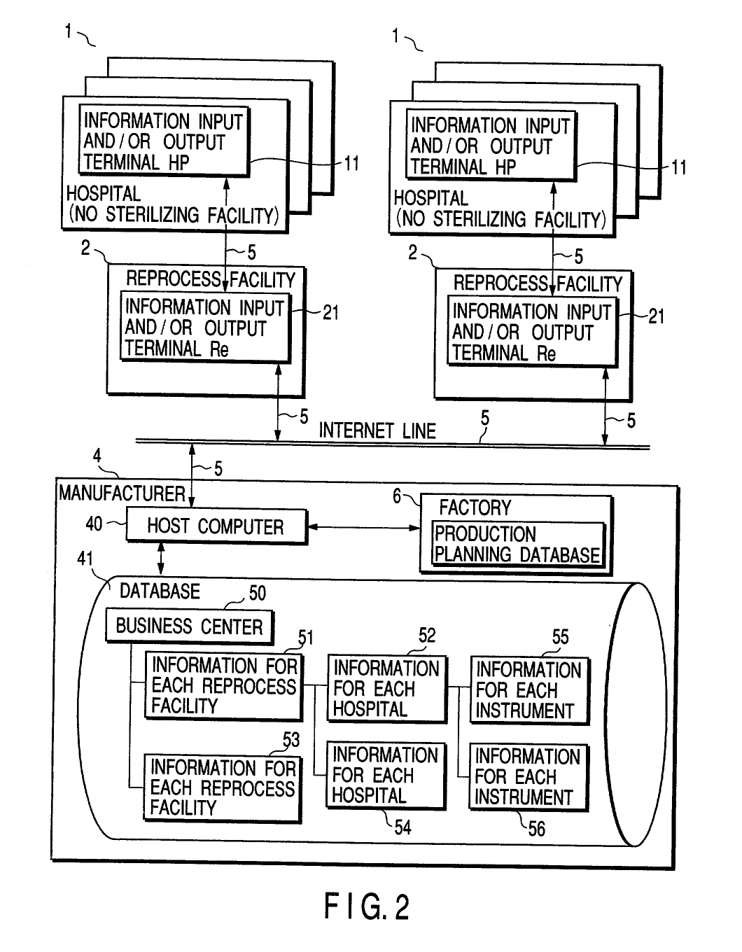

FIG. 2 is a diagram showing a specific construction for realizing the invention. In each hospital 1, there is provided an information input and/or output terminal HP11. When there is an instrument that is difficult to be used due to deformation etc., the hospital 1 can make a “discard request” through the information input and/or output terminal HP11. In addition, “correspondence of canceling adoption of the currently used instrument”, and “order of instruments desired to be newly used” can be also carried out. Further, handing over of instruments can be confirmed through the information input and/or output terminal HP11.

The information input and/or output terminal HP11 is connected to an information input and/or output terminal Re 21 that is served as a reprocess information input unit disposed in each reprocess facility 2 through an electric communication circuit 5. In the case where an instrument that cannot be reused due to damage etc. exists, each of the reprocess facilities 2 provides a new instrument in place of that. At this time, the number of use for the discarded instrument is input and a new instrument is registered through the information input and/or output terminal Re 21.

Further, as for the instruments that can be reused, the number of use for the reprocessed instruments is counted and input through the information input and/or output terminal Re 21.

In addition to that, the information input through the information input and/or output terminal HP 11 can be checked.

The information input and/or output terminal Re 21 is connected to a host computer 40 disposed in the manufacturer 4 through the electric communication circuit 5 (in this embodiment, the Internet circuit).

The host computer 40 accumulates the information, which is input through the information input and/or output terminal HP 11 and the information input and/or output terminal Re 21 and transmitted through the electric communication circuit 5, in a database 41.

A factory 6 in the manufacturer 4 accesses the database 41 through the host computer 40, so that the factory can make a production plan based on the obtained information. Products produced along the production plan are delivered to the reprocess facilities 2 that are in short of stock.

In the database 41, pieces of information 51, 53 on the respective reprocess facilities, pieces of information 52, 54 on the respective hospitals, and pieces of information 55, 56 on the respective instruments are accumulated. These pieces of information are unified and accumulated in each business center 50.

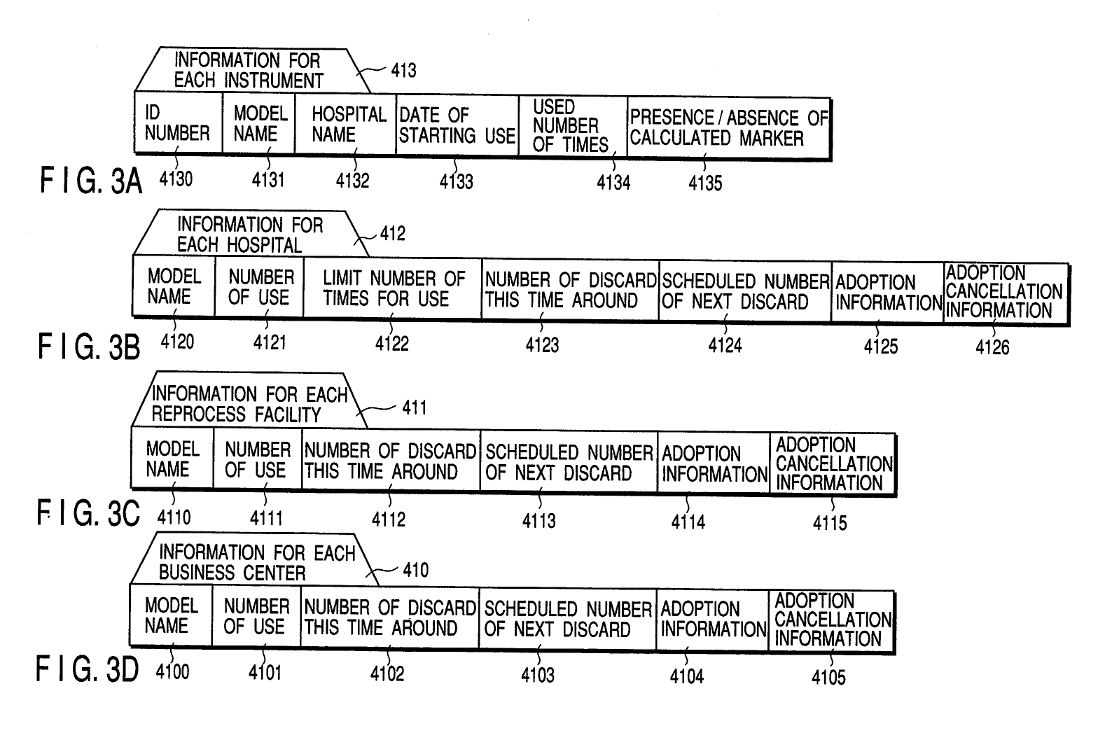

Each piece of the information will be described in detail with reference to FIGS. 3A to 3D.

Information 413 on each instrument shown in FIG. 3A is in a lower category, and is added to each single instrument. More specifically, for each instrument, its own ID number 4130, its model name 4131, hospital name 4132, the date of starting use 4133, the number of use 4134, the presence/absence of the calculated marker 4135 are accumulated in a manner of interaction with each other.

All of such data are registered or updated in each reprocess facility 2. Among the data, the number of use is updated every reprocessing. The calculated marker is checked only once, when the number of use exceeds the limit number of times for use. The limit number of times for use will be described later. The other pieces of information are registered together, when an instrument is newly employed.

Note that, the calculated marker is a marker that is added to an instrument, which is anticipated to be discarded near future and thus calculated in a production plan beforehand. The marker prevents the instrument, which has been calculated in a production plan, from being calculated in the production plan again.

The information 412 on each hospital shown in FIG. 3B is in a middle-level category, and is prepared by gathering up the information on each instrument model in each hospital. More specifically, pieces of information on a model name 4120, the number of use 4121, the limit number of times for use 4122, the number of discard this time around 4123, the scheduled number of next discard 4124, adoption information 4125, and adoption cancellation information 4126, are accumulated. All of the data is registered or calculated in each of the reprocess facilities 2.

The number of use 4121 indicates the number of the instruments that are currently used. The limit number of times for use 4122 indicates the average value of the use number of time until its discard (average number of use: an example of reference information).

The number of discard this time around 4123 indicates the number of the instruments to be discarded this time around. The scheduled number of next discard 4124 indicates the number of the instruments that are newly added with the calculated marker in this time. The adoption information 4125 indicates the number of the instruments for the case where instruments will newly be adopted in accordance with the requirement from the hospital, or the case where the number of the currently used instruments will be increased. Note that, in the case where instruments are newly adopted, the information on each instrument is also newly registered. The adoption cancellation information 4126 indicates the number of the currently used instruments that will be cancelled to adopt due to the requirement from the hospital, or the number of the instruments to be used is reduced.

The information 411 on each reprocess facility 2 shown in FIG. 3C is in an upper-level category, and is the gathered information on each instrument model in each reprocess facility 2. More specifically, pieces of information on a model name 4110, the number of use 4111, the number of discard this time around 4112, the scheduled number of next discard 4113, adoption information 4114, and adoption cancellation information 4115, are accumulated.

All of the data is registered or calculated in each reprocess facility 2. The number of use 4111, the number of discard this time around 4112, the scheduled number of next discard 4113, adoption information 4114, and adoption cancellation information 4115 are the sum-up numbers of the information 412 for each of the hospitals, respectively.

Information 410 on each business center 50 shown in FIG. 3D is in the uppermost category, and is the information that is prepared by gathering up the information on the respective instruments for each of the business centers 50. The kind of data is the same as one in the information 411 on each of the reprocess facilities 2. In the information 410, pieces of information on a model name 4100, the number of use 4101, the number of discard this time around 4102, the scheduled number of next discard 4103, adoption information 4104, and adoption cancellation information 4105, are accumulated. Each of the above information is obtained by summing up the number of the information 411 on each of the reprocess facilities 2.

The pieces of data 4100 to 4105 are totaled in each business center 50. If necessary, the process can be performed reversely, i.e., starting from the uppermost categorized information 410 to the lower categorized information 413 on each instrument. The factory 6 develops a production plan based on the information 410 on each business center 50, or the like.

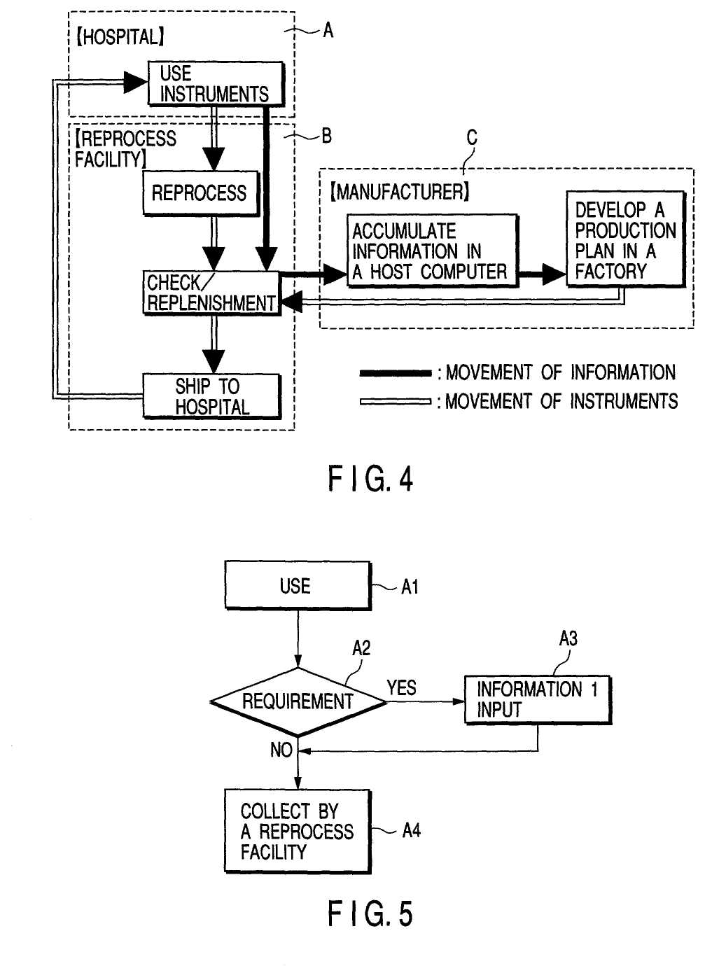

Next, a function of the present embodiment will be described with reference to FIGS. 4 to 7. FIG. 4 shows the movement of the aforementioned instruments and information.

Assuming that a section pertaining to the hospital 1 is A-block, a section pertaining to the reprocess facility 2 is B-block, and a section pertaining to the manufacturer 4 is C-block, the A, B, and C-blocks will be described with reference to FIGS. 5 to 7.

A function of the A-block will be described with reference to FIG. 5. A user uses an instrument (Step A1). The used instrument is put into a collection box for used instruments. After use of the instrument, the user determines whether or not to have some requirement (Step A2). When the answer is “YES”, the user inputs “information 1” expressing so through the information terminal HP11 (Step A3), and then proceeds to the Step A4. If the determination in the Step A2 was “NO”, the process goes to the Step A4 immediately.

In this case, “some requirement” includes, for example, “discard request” of the instrument that became difficult to be used due to deformation etc., “adoption cancellation request” of the currently used instrument, “new adoption request” for a new product, or the like. These pieces of information are registered in the information 413 on each instrument shown in FIG. 3A. In the Step A4, the used instruments are collected regularly in each of the reprocess facilities 2.

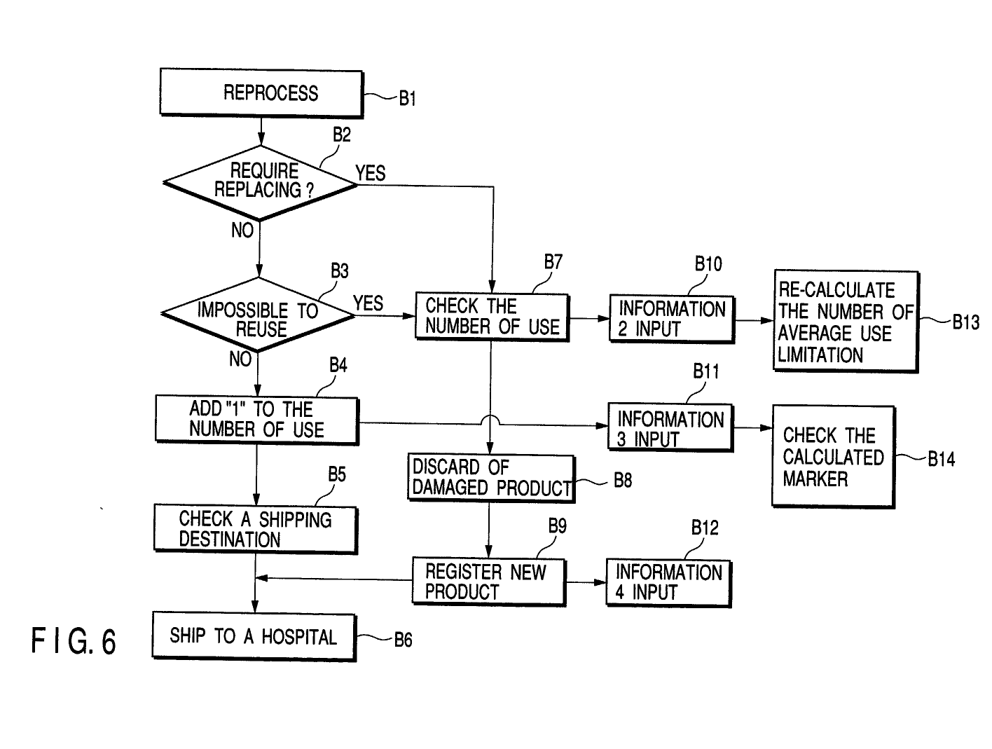

A function in the B-block will be described with reference to FIG. 6. The reprocess facility 2 disinfects or sterilizes the collected an instrument so as to reuse the relevant instruments (Step B1). Then, it is determined whether or not the user requires the replacement through the “information 1” (Step B2). When the user requires the replacement, the number of use of the instrument is checked (Step B7), and its number is input as “information 2” through the terminal 21 (Step B10).

After that, the instrument is discarded (Step B8), and a new instrument is employed in place of the discarded one and registered it (Step B9). The information on the employed instrument is input as “information 4” through the information input and/or output terminal Re 21 (Step B12). The “information 41” is registered as the information 413 on each instrument shown in FIG. 3, and the registered information 413 is updated with the “information 2”.

Further, the number of average use limitation is calculated (Step B13) based on the “information 2” input in the Step B10, and the information 412 on each hospital shown in FIG. 3 is updated.

In the Step B2, when it is determined that no replacement requirement exists, the process goes to the Step B3. In the Step B3, it is determined whether or not the instrument can be reused after reprocessing. If the instrument cannot be reused, the usage number of the instrument is checked (Step B7) and the number is input as the “information 2” through the information input and/or output terminal Re 21 (Step B10). After that, the instrument is discarded (Step B8). In this case, a new instrument is employed in place of the discarded one and registered (Step B9). The information on the employed instrument is input as “information 4” through the terminal 21 (Step B12). The “information 2” and “information 4” are treated in the same manner described above.

In the case where the instrument cannot be reused in the Step B3, the process goes to the Step B4. In the Step B4, the number of use of the instrument is counted once, the current number of use is input as “information 3” through the information input and/or output terminal Re 21 (Step B11). Through the “information 3”, the information 413 on each instrument is updated. Further, the current number of use is compared to the number of average use limitation. In the case where the current number of use exceeds the number of average use limitation, the calculated marker is added while assuming that the discard has been scheduled (Step B14). The information of the calculated marker is added to the information 412 on each instrument.

After the Step B4, the process goes to the Step B5 so as to check the name of hospital to which the instrument is to be sent, with the ID number of the relevant instrument. In the next Step B6, the instrument in the Step B5 and the newly employed instrument in the Step B2 or Step B3 are sent together to the checked hospital.

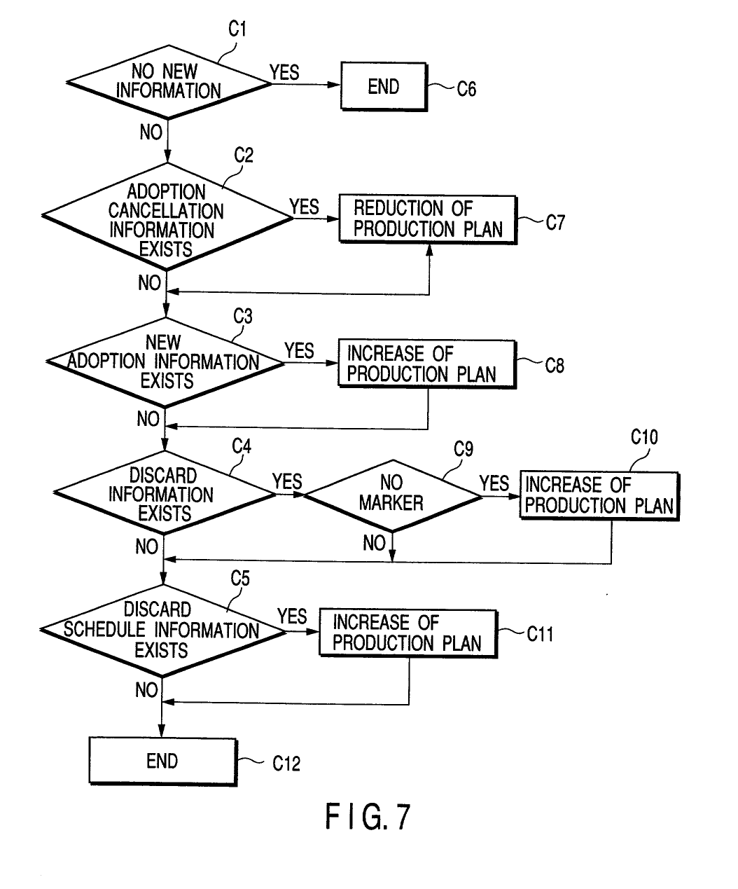

Next, a function in the C-block will be described with reference to FIG. 7. In the Step C1, the manufacturer 4 determines whether or not new pieces of information (“information 1” to “information 4”) have occurred in the A-block and B-block. In the case where no new information occurs, the process ends (Step C6). On the other hand, in the case where new information occurs, the process goes to the next Step C2.

In the Step C2, it is determined whether or not the information on adoption cancellation of the instrument based on the “information 1” is included in the new information. When the information on adoption cancellation is included, the amount corresponding to the amount of adoption cancellation is reduced from the amount in an instrument production plan (Step C7), and proceeding to the Step C3. On the other hand, when the information on adoption cancellation is not included, the process goes to the Step C3 immediately.

In the Step C3, it is determined whether or not adoption information on the instrument through the “information 1” is included in the new information. When the new adoption information is included, the amount corresponding to the amount of scheduled adoption instruments is added to the amount in the instrument production plan (Step C8), and proceeding to the Step C4. On the other hand, when no new adoption information is included, the process goes to the Step C4 immediately.

In the Step C4, it is determined whether discard information on the instrument through “information 1” or “information 2” is included or not. When the discard information is included, the presence/absence of the calculated marker is determined (Step C9). In the case where no calculated marker exists, the amount corresponding to the amount for discarding is added to the amount in an instrument production plan (Step C10). When the calculated marker exists in the Step C9 or after the Step C10, the process goes to the Step C5.

When no discard information is determined to exist in the Step C4, the process goes to the Step C5. In the Step CS, it is checked whether or not discard schedule information on instruments is included in the new information. The discard schedule information is the information indicated with the scheduled number of next discard 4124 in the information 412 on each hospital. When the discard schedule information exists, the amount of the discard-scheduled instruments is added to the amount in an instrument production plan (Step C11). In the Step CS, when no discard schedule information exists, or after the Step C11 is completed, the process ends (Step C12).

Through the method described above, the manufacturer can accurately grasp the number of discarded instruments, and the number of instruments scheduled to be discarded near future, thereby developing a highly accurate production plan.

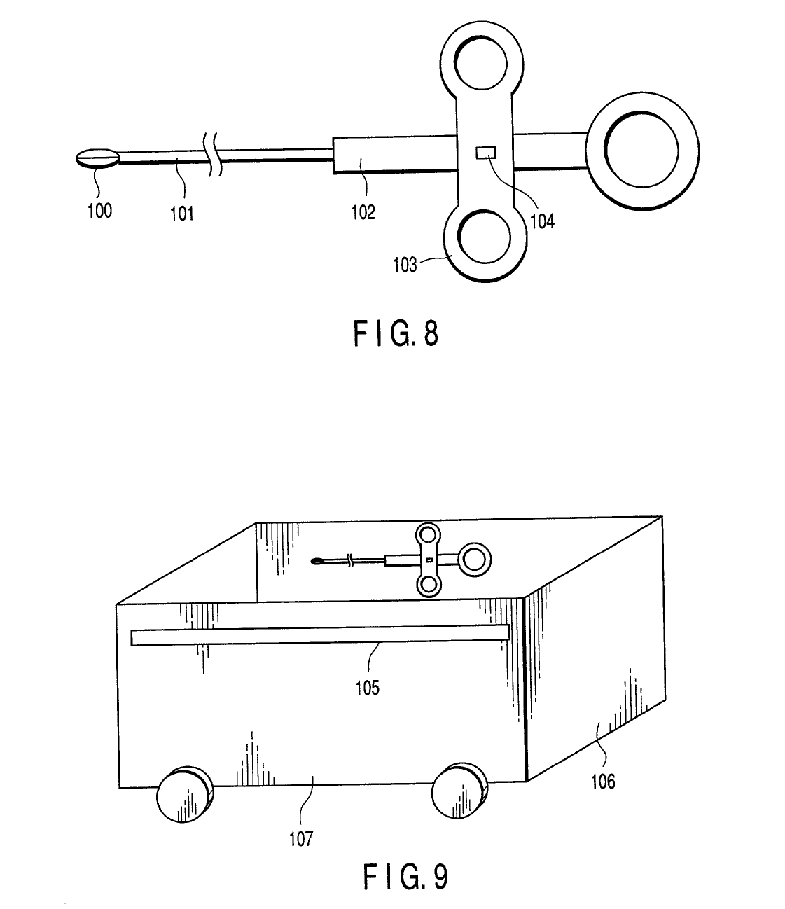

Further, according to the invention, a device to identify each instrument may employ a barcode that is attached on a body of an instrument. And further, a transponder chip 104 with an ID number may be buried in the body of the instrument as shown in FIG. 8. The body of the instrument shown in FIG. 8 comprises a forceps-like tip 100, a sheath 101, a handle body 102, and a slider 103, etc.

When the transponder chip 104 is used, a storage box for used instruments may be a storage box for used instruments 107 with a transponder reading device 105 used as a information input and/or output terminal 106 as shown in FIG. 9. In this case, if only the instruments are put into the storage box for used instruments 107, the instruments to be reprocessed are recognized, and the number of use can be counted.

Note that, the discard schedule information is not limited to the information formed only based on the number of average use limitation. For example, the discard schedule information may be formed with use of the bathtub curve showing the relationship between a failure incidence rate and the number of use.

On the other hand, in the case where the typical indication of the model is certainly recognized before the instrument becomes nonusable, the indication can be used as the discard schedule information. More positively, the instrument designed to show the indication of becoming nonusable may be used.

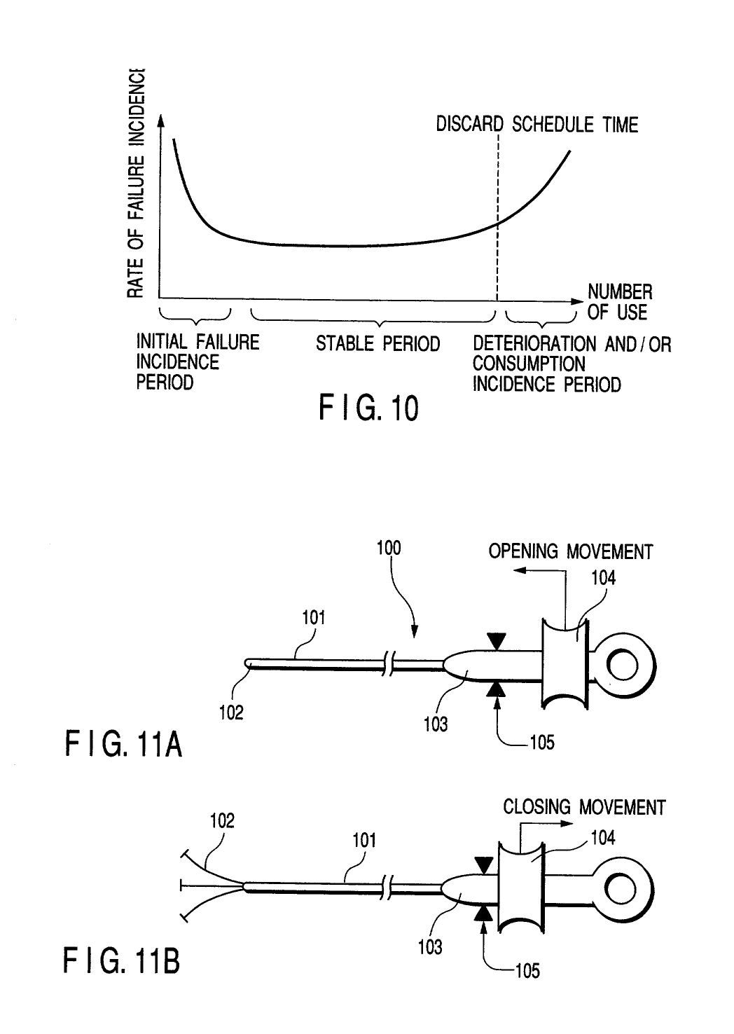

Hereinafter, an embodiment using the bathtub curve will be described. The bathtub curve is a graph with the failure incidence rate indicated in a vertical axis and with the number of use indicated in a horizontal axis, as shown in FIG. 10. In general, this graph shows a phenomenon that, when the number of use is small, the failure incidence rate is high due to an initial failure. After that, the failure incidence rate decreases, and then the rate becomes stable at the certain rate. Then, as the number of use is increased, the failure incidence rate begins to increase again due to deterioration or consumption of the instrument.

In this graph, if the time for discard schedule is set at the point where the failure incidence rate begins to increase again, the time of discard can be anticipated further accurately. Therefore, with use of the bathtub curve, the discard schedule information can also be obtained.

Further, it is considerable to obtain the discard schedule information based on the various standard values (another example of the reference information) set for the respective products without use of the numeral value such as an average number of use. For example, the discard schedule information can be formed based on whether or not the operation competence of an instrument satisfies the standard value.

FIGS. 11A and 11B show the measurement status of opening or closing competence of a tripod grip forceps 100, wherein FIG. 11A shows the status at the time of measuring its opening competence, and FIG. 11B shows the status at the time of measuring its closing competence. As shown in the drawings, an operation section 103 of the tripod grip forceps 100 is fixed, and competence for opening or closing a grip portion 102 is measured while moving a slider 104. In this case, it is assumed that the standard value of the movement competence of the slider 104 corresponding to the opening or closing competence is 4.9 N. The numeral 105 denotes an operation section fixing jig 105.

In the case where the opening or closing competence of the tripod grip forceps 100 after reprocessing is measured and the relevant competence is equal to or above 4.9 N, the operation performance is becoming worse. In this case, it can be determined that this instrument is very likely to be discarded near future. Thus, based on the opening or closing competence, the discard schedule information can be obtained.

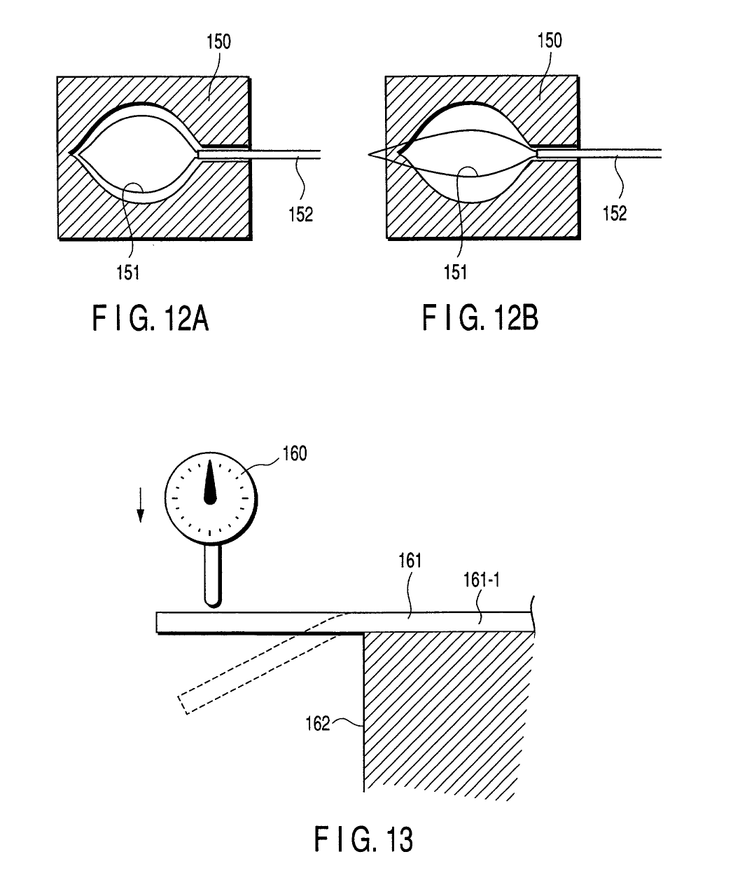

For another example, the discard schedule information can be formed depending on whether or not the form of an instrument satisfies the standard. A wire form of a basket grip forceps, or a high frequency snare, etc. exerts a great influence on the performance of the instrument. For example, a template, which imitates the loop form of the snare wire, is prepared beforehand, and the snare wire is put to the template after reprocessing. FIG. 12A shows the state where the snare wire passes through the template without sticking, and FIG. 12B shows the state where the snare wire cannot pass through the template because of sticking. In FIGS. 12A and 12B, the numeral 150 denotes a template, and the 151 denotes a snare wire, and the 152 denotes a sheath.

The state shown in FIG. 12A is a normal state, wherein the snare wire 151 can be continuously reused. In the state shown in FIG. 12B, the snare wire 151 is deformed. This fact probably has a disadvantage for its use and thus the wire is in the state of being discarded soon. In such a manner, the discard schedule information can be obtained based on the form of the snare wire 151.

For still another example, the discard schedule information can be formed depending on whether or not the deflection of a sheath for the instrument satisfies the standard value. As for an instrument such as a contrast tube etc., which is used while being inserted into a duodenal papilla, may cause its operation performance to deteriorate in the case where the deflection of the sheath is changed.

FIG. 13 shows the state where the deflection on the tip side of the contrast tube is being measured. A measurement method is constituted by fixing a sheath 161 on a mounting 162, pressing a deflection measure 160 down to the sheath 161 from above, and measuring the degree of pushing-in force to the deflection of the sheath 161. The 161-1 denotes a sheath tip portion. In this case, when the deflection does not satisfy the pre-set standard value, it can be determined that the operation performance of the tube has deteriorated. This fact means that the time of discard for the tube comes soon. Thus, the discard schedule information can be obtained based on the deflection of the sheath 161. In these cases, since the time of discard is estimated by checking the performance state, which directly pertains to each of main functions in instruments, the discard schedule time can be anticipated more accurately in comparison with the case using the number of use, or the like.

According to the invention, since a production plan can be developed based on the state of use in a medical care site, the demand being likely to occur in the future can be grasp accurately. As a result, the necessary stock can be reduced to the minimum extent.

Thus, it becomes possible to reduce expenses for managing the stock, and further, the time required for laundering products is dramatically shortened.

Furthermore, as the side benefit of the invention, reprocess is not necessary in a hospital, the hospital can reuse instruments as if they were disposable ones. Since professionals educated by a manufacturer checks the use limit of instruments, the quality of instruments can be maintained in a high-level. In reprocessing, instruments that cannot be used are discarded and new ones are sent, and thus, instruments of the same number as collected ones are always returned to the hospital. Therefore, the hospital does not need to manage the stock and no shortage or no delay in delivering occurs. The reprocess facilities carry out the discard of instruments that cannot be used again, and thus the hospital does not need to care the discard.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A production planning calculating apparatus comprising:
a reprocess information input unit which inputs reprocess information in accordance with a reprocessing of a particular reprocess apparatus sent from a particular medical facility;
a reprocess reference information storage unit which stores reference information based on a possible value for reprocessing in the particular reprocess apparatus; and
a production planning information calculating unit which calculates production planning information on the particular reprocess apparatus, based on the reprocess information input from the reprocess information input unit and the reference information stored in the reprocess reference information storage unit.

2. A production planning calculating apparatus comprising:
an apparatus identification information input unit capable of inputting apparatus identification information to identify a particular reprocess apparatus;
a medical facility information input unit capable of inputting information on medical facility which possesses the particular reprocess apparatus;
a reprocess number information input unit capable of inputting information on the reprocess number corresponding to the reprocess number to the particular reprocess apparatus;
a reprocess information managing unit which manages the apparatus identification information, medical facility information, and the reprocess number information in a manner of corresponding respectively;
an average reprocess number calculating unit which calculates information on the average possible reprocess number in a particular medical facility, based on the apparatus identification information, medical facility information, and the reprocess number information, these pieces of information being managed by the reprocess information managing unit; and
a production planning information calculating unit which calculates production planning information of the particular reprocess apparatus, based on the apparatus identification information, medical facility information, and the reprocess number information, and the possible reprocess number information, these pieces of information being managed by the reprocess information managing unit.

3. A production planning calculating apparatus comprises:
a reprocess information input device which inputs reprocess information in accordance with a repressing of a particular reprocess apparatus sent from a particular medical facility;
a production planning information output device which calculates production planning information on the particular reprocess apparatus and outputs the calculated information, with use of the reprocess information input from the reprocess information input device and reference information based on a possible value for reprocessing in the particular reprocess apparatus; and
a communication device which connects the reprocess information input device and the production planning information output device to each other and enables reception and/or transmission of information between the devices.

4. A production planning calculating program causing a computer to realize:
a reprocess information input function which inputs reprocess information in accordance with a reprocessing of a particular reprocess apparatus sent from a particular medical facility;
a reprocess reference information storage function which stores reference information based on a possible value for reprocessing in the particular reprocess apparatus; and
a production planning information calculating function which calculates production planning information on the particular reprocess apparatus, based on the reprocess information input from the reprocess information input function and the reference information stored by the reference information storage function.
